(19) United States
(12) Patent Application Publication
(10) Pub. No.: US 2024/0202649 A1
(43) Pub. Date: Jun. 20, 2024

(54) TRANSPORTATION PREDICTION WITH MACHINE LEARNING MODEL

(71) Applicant: SAP SE, Walldorf (DE)

(72) Inventors: Jing Gu, Shanghai (CN); Mingjie Dong, Shanghai (CN); Jie Zhao, Shanghai (CN)

(73) Assignee: SAP SE, Walldorf (DE)

(21) Appl. No.: 18/081,437

(22) Filed: Dec. 14, 2022

(51) Int. Cl. G06Q 10/0833; G06Q 10/083

(52) U.S. Cl. CPC G06Q 10/0833; G06Q 10/0838

(57) ABSTRACT

A machine learning model is trained using past estimations of transit time and actual observed transit times. Other training features can include day-of-the-week of load, hour-of-the-day of load, load locations, and carrier identifier. Subsequent planning can invoke the machine learning model, which can predict an actual transit time. The technologies can be integrated into track and trace functionality. Useful for improving planning and assisting inexperienced users.

### FIELD

The field generally relates to machine learning in the supply chain management and logistics domains.

### BACKGROUND

Transportation planning can be difficult due to the number of factors involved. Software suites have been developed to aid in distributing items and the related tasks. However, the software still has its limitations, especially when applied at a global scale.

For example, determining how long it will take to ship an item to a destination is notoriously difficult to predict exactly. Domains such as supply chain management (SCM) rely on accurate prediction, so experts have emerged who are skilled at accurate prediction.

However, there are a couple problems with the current arrangements. First, the experts may be good, but conditions change over time, and it may take time even for the best expert to adapt to new conditions. Second, there are a limited number of experts. Therefore, when the demand outstrips the availability of experts, inexperienced planners can find themselves struggling without the benefit of accurate planning experience.

Inaccurate planning leads to wasted resources, overloaded ports, empty or overflowing warehouses, and other problems associated with poor supply chain management practices.

There therefore remains a need for better solutions for accurate planning in the transportation domain.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a computer-implemented method comprises receiving a set of attributes for a planned load, wherein the attributes comprise an estimated transit time attribute and day-of-the-week attribute; applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and with the machine learning model, based on the attributes comprising the day-of-the-week attribute and the estimated transit time attribute, generating a predicted actual transit time difference.

In another embodiment, a computing system comprises at least one hardware processor; at least one memory coupled to the at least one hardware processor; and one or more non-transitory computer-readable media having stored therein computer-executable instructions that, when executed by the computing system, cause the computing system to perform: receiving a set of attributes for a planned load, wherein the attributes comprise an estimated transit time attribute and day-of-the-week attribute; applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and with the machine learning model, based on the attributes comprising the day-of-the-week attribute and the estimated transit time attribute, generating a predicted actual transit time difference.

In another embodiment, one or more non-transitory computer-readable media have stored therein computer-executable instructions that when executed by a computing system, cause the computing system to perform receiving a set of attributes for a load, wherein the attributes comprise an estimated transit time of the load attribute, a day-of-the-week of the load attribute, an hour-of-the-day of the load attribute, and a carrier identifier of the load attribute; applying the attributes to a machine learning model, wherein the machine learning model is trained with training attributes comprising the estimated transit time of the load attribute, the day-of-the-week attribute, the hour-of-the-day of the load attribute, and the carrier identifier attribute and the machine learning model is trained to predict observed transit time difference calculated from observed actual transit timestamps of past loads; and with the machine learning model, based on the attributes, generating a predicted actual transit time difference indicating a prediction of an actual transit time.

As described herein, a variety of features and advantages can be incorporated into the technologies as desired.

### BRIEF DESCRIPTION OF THE DRAWINGS

FIG. 1 is a block diagram of an example system implementing transportation prediction with a machine learning model.

FIG. 2 is a flowchart of an example method of transportation prediction with a machine learning model.

FIG. 3 is a block diagram of example features used during training of a machine learning model that generates transportation predictions.

FIG. 4 is a block diagram showing an example structure for representing tracked processes in a supply chain management application.

FIG. 5 is a block diagram of an example table representing training data for a machine learning model.

FIG. 6 is a block diagram of an example table representing input data (for prediction) for a machine learning model.

FIG. 7 is a block diagram of an example table representing output (prediction) data of a machine learning model.

FIG. 8 is a block diagram of an example architecture implementing transportation prediction with a machine learning model.

FIG. 9 is a block diagram of an example computing system in which described embodiments can be implemented.

FIG. 10 is a block diagram of an example cloud computing environment that can be used in conjunction with the technologies described herein.

### DETAILED DESCRIPTION

### Example 1—Overview

Although there are automated mechanisms in place for predicting transit time, transportation scheduling continues to be controlled manually. Experienced staff know how to plan shipping, but non-experienced or new staff find planning to be difficult. Bringing new staff up to speed requires time and resources for training.

Without accurate planning, warehouses sit empty, or they overflow with goods; ports may be crowded with trucks and ships. Such situations adversely affect the proper usage of limited resources, leading to unnecessary waste of resources, time, and energy.

Therefore, current systems rely heavily on experienced staff who can provide such accurate planning; unfortunately, such experienced staff are in short supply.

As described herein, a machine learning approach can leverage data on past recorded shipments to make accurate predictions about transit time. Such an approach can help new staff come up to speed because the machine learning model is aware of key attributes such as day-of-the-week, hour-of-the-day of shipment, carrier, and the like.

As another benefit, the performance of even experienced staff can be improved with assistance from machine learning.

As time goes on, more data can be used to build the model, which will improve the accuracy of planning. With the benefit of the high accuracy of the solution, terminals and ports can improve their efficiency and warehouse utilization greatly.

The technologies can be useful in any of a variety of planning scenarios and can be implemented in concert with supply chain management software.

Other benefits are possible as described herein.

The described technologies thus offer considerable improvements over conventional techniques.

### Example 2—Example System Implementing Transportation Prediction with a Machine Learning Model

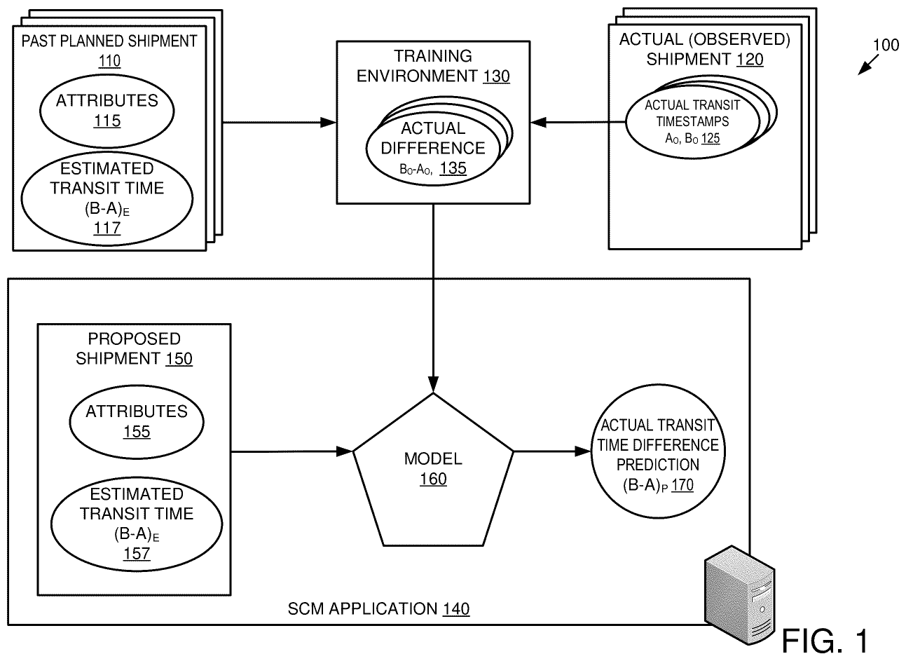

FIG. 1 is a block diagram of an example system 100 implementing transportation prediction with a machine learning model. In the example, past planned shipment data comprising records 110 having an estimated transit time 117 (e.g., (B—A)_{E}) and other attributes 115 as well as actual (observed) shipment data comprising records 120 having observed transit timestamps 125 for source location A and destination location B (e.g., A_{O} and B_{O}) are used as input to a training environment 130. Actual differences (e.g., B_{O}-A_{O}) 135 can be determined between the timestamps A_{O} and B_{O} for respective of the records 110, whether within or outside of the training environment 135. As described herein, a supply chain management application can represent planned events and actual events internally in a database as records, and such information can be used to correlate the differences 135 with the counterpart (e.g., respective) shipment records 110. One or more identifiers can link a past shipment record to its counterpart actual shipment record, allowing the training data to be staged and training to take place.

The training environment can produce a trained machine learning model 160 based on the input data 110 and 135.

When a new proposed shipment is processed by supply chain management application 140, the shipment record 150 comprises an estimated transit time 157 (e.g., (B—A)_{E}) having a format similar to estimated transit time 117 as well as other attributes 155 having formats similar to attributes 115. Derived or calculated attributes can be included. The trained model 160 then generates an actual transit time difference prediction 170 (e.g., (B—A)_{P}) based on the attributes 155 and estimated transit time 157 of the proposed shipment 150. The actual transit time difference prediction 170 represents a prediction of the difference between the given start time (for the source location) and when the shipment will actually arrive at its destination location.

As described herein, the actual transit time difference prediction 170 can be used for a variety of scenarios. For example, the actual transit time difference 170 can be substituted for the estimated transit time 157 of a proposed shipment (e.g., the value is overwritten in the record). Further calculations can be done. For example, a recommended planned timestamp of the arrival at the destination can be calculated as follows:

$$recommended planned timestamp for destination B = planned time stamp for source location A + predicted actual transit time difference$$

Further components can be provided. Deviation determinations can be performed. For example, a supply chain management application user interface can be configured to analyze the deviation (e.g., difference) of the planned transit time from the predicted actual transit time difference, and, responsive to determining that the deviation between the two exceeds a threshold, taking a remediation action. For example, remediation actions can comprise blocking shipment processing for the shipment, requiring an override for the shipment (e.g., by an authorized user identifier, providing a reason, etc.), or the like. The shipment can then be unblocked accordingly and processed by the system.

The supply chain management application 140 can be implemented in a cloud-based environment 120 provides services to client devices 110. For example, an enterprise can take advantage of the services by connecting to the cloud via client computing devices.

In practice, the systems shown herein, such as system 100, can vary in complexity, with additional functionality, more complex components, and the like. For example, in practice, the number of past shipments can greatly exceed those shown. Also, orchestration of the training data can be accomplished through distributed processing across a plurality of nodes. Additional components can be included to implement security, redundancy, load balancing, report design, and the like.

Although some computing systems use a singular form (e.g., client computer, server computer, or the like), in practice, such computing systems can comprise plural computers (e.g., a server farm, data center, or the like).

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, records 110, 120 actual timestamps 125, actual differences 135, the model 160, and the like can be stored (e.g., persisted) in one or more computer-readable storage media or computer-readable storage devices. The technologies described herein can be generic to the specifics of operating systems or hardware and can be applied in any variety of environments to take advantage of the described features.

### Example 3—Example Method of Transportation Prediction with a Machine Learning Model

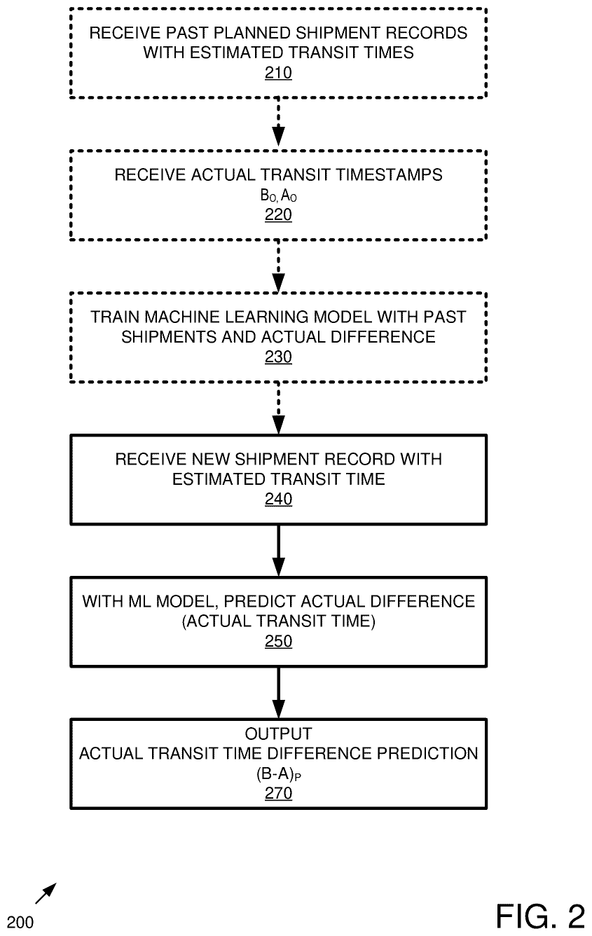

FIG. 2 is a flowchart of an example method 200 implementing transportation prediction with a machine learning model and can be performed, for example, by the system of FIG. 1. As described herein, the system can support a large number of shipments tracking both estimated transit time and actual transit time. For example, a supply chain management application can provide a track and trace functionality that includes data that can be used for training and subsequent predictions.

Although the example describes a situation involving training activities 210-230, the technologies can be useful in scenarios where training has already been performed (e.g., in advance of predicting a transit time difference with new shipment records).

At 210, past planned shipment records are received. As described herein, such records can represent planned events and include attributes that can be used as features for training as described herein. As described herein, such records can include an estimated transit time (e.g., (B—A)_{E}) for the shipment. In practice, although the records are called “planned,” they are for shipments that have already been executed (e.g., actual timestamps are now available for the records showing actual transit time).

At 220, the actual transit times are received. For example, records of actual events corresponding to the planned events can indicate actual time stamps that can be converted into an actual (e.g., observed) time. An identifier links the records of actual events to counterpart records of planned events. In practice, times can be computed time stamps (e.g., A_{O} for a timestamp for departure from the source location and B_{O} for a timestamp of arrival time at the destination location); a difference between the timestamps indicates the actual transit time (e.g., B_{O}-A_{O}) and can be calculated and used during training.

At 230, a machine learning model is trained with past planned shipment attributes and the actual transit times. Other features can be incorporated as described herein.

At 240, a new shipment estimate is received. As described herein, one or more records can comprise an estimated transit time and other attributes, or such a time can be derived or calculated from one or more records.

At 250, a transit time difference (B-A)_{P} is predicted (e.g., computed) with the new shipment estimate as input.

At 270, the predicted actual transit time difference (B-A)_{P} is output.

As described herein, subsequent actions can be based on the predicted actual transit time difference. As described herein, a predicted actual timestamp for destination location B can be easily calculated with the predicted transit time difference.

Deviation determinations can be performed as described herein, and remediation actions can be taken as described herein based on such deviation determinations.

In practice, 240-270 can be performed repeatedly for new planned shipments. Training 210-230 can be performed periodically to avoid ineffectiveness of the trained machine learning model.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

Similarly, a computing system can comprise at least one hardware processor, at least one memory coupled to the at least one hardware processor, and one or more non-transitory computer-readable media having stored therein computer-executable instructions that, when executed by the computing system, cause the computing system to perform any of the methods described herein.

The illustrated actions can be described from alternative perspectives while still implementing the technologies. For example, receiving a prediction can be described as sending a prediction depending on perspective.

### Example 4—Example Shipment

In any of the examples herein, a shipment (sometimes called “load” herein) has an internal representation in software that typically comprises attributes (attribute name, attribute value pairs) that comprise a source location (e.g., shipment origin), a destination location, and other details as described herein.

### Example 5—Example Integration

In any of the examples herein, the technologies can be integrated into a supply chain management application with track and trace functionality, which is typically provided as a cloud-based service to clients.

In one implementation, the technologies are integrated into the SAP Logistics Business Network provided by SAP SE of Walldorf, Germany, that connects those involved in the supply chain, allowing companies to access information related to supply chain management in a single location. For example, the Global Track-and-Trace option can leverage the technologies described herein to improve accuracy of predicted arrival time of shipments of goods in the supply chain.

### Example 6—Example Estimated Transit Time

In any of the examples herein, an estimated transit time can be provided as part of a planned shipment. In practice, the value represents the difference between when the shipment arrives at its destination location B and when the shipment leaves its source location A (e.g., B—A)_{E}. However, in practice, the estimated transit time can take the form of a single value (e.g., the estimate of how long the shipment will take). The value can be in any of a variety of time units such as days, hours, minutes, seconds, or the like.

### Example 7—Example Actual Transit Time Difference Prediction

In any of the examples herein, an actual transit time difference (e.g., (B-A)_{P}) can be predicted by a machine learning model. The difference represents the expected transit time for a shipment having the attributes input to the model. As described herein, the predicted value can be used as a recommendation, or remedial actions can be taken. In practice, the actual transit time difference can take the form of a single value (e.g., a prediction of how long the shipment will take). The value can be in any of a variety of time units such as days, hours, minutes, seconds, or the like.

### Example 8—Example Remedial Actions

In any of the examples herein, the prediction can be used for further actions. In practice, the shipment can be replanned based on the result. For example, the predicted actual transit time difference can be substituted for the estimated transit time attribute in the database, and thus the shipping record. Because a recommended planned timestamp for the destination event (event B) can be calculated as described herein, the recommended planned timestamp can similarly be substituted for the planned time stamp of the destination event (event B).

Another possible action is to generate an alert if the estimated (planned) time deviates from the predicted time by a configurable threshold. Such an alert can be displayed in a user interface, block further action, or be recorded for review later.

Another possible action is to block shipment until the deviation is under a configurable threshold. Override can be supported as described herein.

Subsequent to incorporating the prediction and replanning the shipment, the shipment can be actually scheduled, and the items shipped according to the prediction. In practice, such an approach can result in a shipment that is accurately planned, resulting in better use of resources as described herein.

Another use for the prediction is human planner training. For example, a planner training user interface implementing any of the following can be presented. A deviation can be calculated and displayed as part of the shipping process. The planner can then receive accurate feedback. Further, a running record of deviation can be tracked and provided at the end of a period, batch, or the like. Shipments can be suspended until the end of such time period, and the planner can be reviewed or self-assess progress toward accuracy goals. After accuracy goals are met, the planner can be certified as having been trained. Uncertified planners can be placed in a supervised category until certification is completed.

Other uses of the prediction can be incorporated as appropriate.

### Example 9—Example Machine Learning Model

In any of the examples herein, a machine learning model can take the form of any of a number of models effective at making future predictions based on past results. Such models include artificial neural networks, linear regression, decision trees, support-vector machines, Bayesian networks, genetic algorithms, isolation forest, and the like.

As described herein, an implementation using linear regression is suited for the problem domain. Thus, the machine learning model can comprise a linear model applying linear regression to model a linear relationship for predicted actual transit time difference as a dependent variable. Elastic net regularization can be applied.

### Example 10—Example Attributes

In any of the examples herein, a variety of attributes can be used for training and prediction. Such attributes can be fields, database fields, properties, or the like. In practice, an attribute is represented by an (attribute name, attribute value) pair; however, the attribute name is sometimes implied by virtue of position, location, or the like.

As described herein, values derived or calculated from one or more attributes can also be used.

### Example 11—Example Training Features

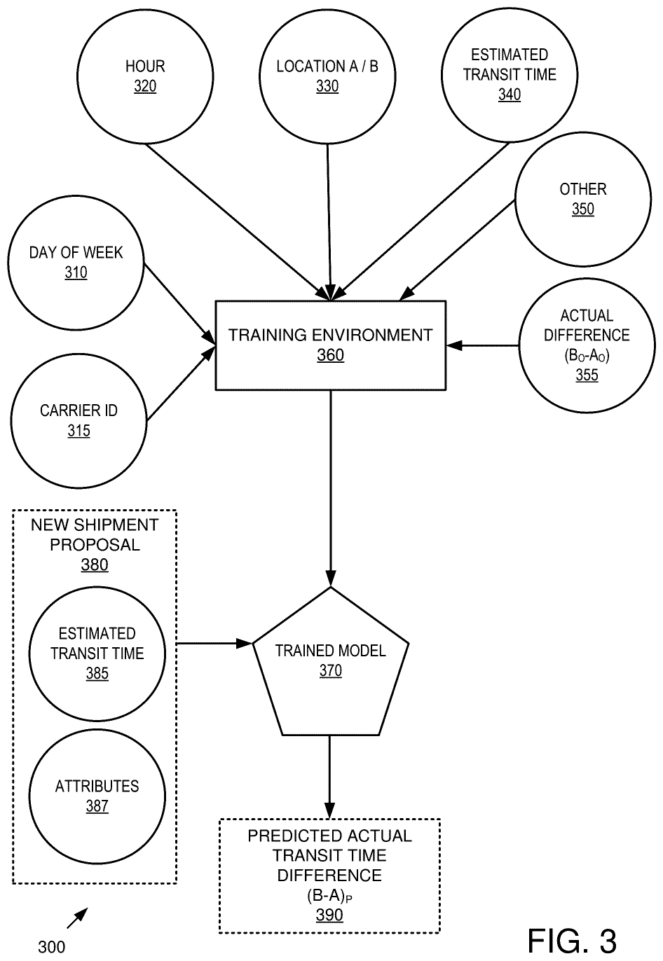

FIG. 3 is a block diagram of example features 300 used during training of a machine learning model 370 that can be used in any of the examples herein. The features are typically drawn from events represented by records in a database that contain various attributes related to a planned or actual shipment. For example, a planned shipment can be represented by a record that includes many of the attributes shown. Such attributes can be used as features during training.

As shown, the actual time difference (B_{O}-A_{O}) can be used in that the model 370 is trained to predict the actual time difference 355, which can be acquired by taking a difference between timestamps B_{O} and A_{O} associated with a destination location B timestamp and a source location A timestamp of an actual event (observed shipment) counterpart of the planned shipment record for the event having the attributes used for training.

As shown, the features can include a carrier identifier attribute 315, a day-of-the-week of shipment attribute 310 (e.g., Monday, Tuesday, etc.), an hour-of-the-day of shipment attribute 320, a source location A attribute and a destination location B attribute 330, an estimated transit time attribute 340, and possible other attributes 350.

The training environment 360 can accept input data for a large number of past planned shipments and their counterpart observed events with timestamps and generate the trained model 370.

Subsequently, when a new shipment proposal with an estimated transit time 385 (e.g., an estimated value of how long the shipment will take, typically from user input) and other attributes 387, the trained model 370 can generate a predicted actual transit time difference (B-A)_{P} 390.

Before deployment, validation can be performed on the model 370 to verify that it is predicting well by comparing predictions 390 to actual differences 355 (e.g., using test data) and computing metrics such as precision and recall.

Other features 350 are possible, including a variety of attributes such as country of shipment, or the like.

Derived features based on combinations or segments of attributes can also be included in training.

### Example 12—Example Details of Implementation

In any of the examples herein, an application function library can define functions that can be called within procedures to perform analytics procedures. For example, SAP HANA Cloud, SAP HANA Database offers the Predictive Analysis Library.

In a supply chain management application, a track and trace option can track processes that are influenced by business events. Tracked processes and business events have a common core behavior and share a common set of basic attributes.

A tracked process can comprise the following:
1. Involved parties acting in or being affected by the process.
2. Tracked multiple other processes.
3. A set of planned events that are expected to happen within the tracked process. Planned events can be called “milestones” in some applications.
4. A set of events that actually happened against the process. This could be a realization of a planned event of an unplanned event.

### Example 13—Example Planned and Observed Events

In a track and trace functionality of a supply chain management application, one can obtain the carrier, planned business time, actual business time, and other properties from the database. One can then use the data to prepare training and predicting.

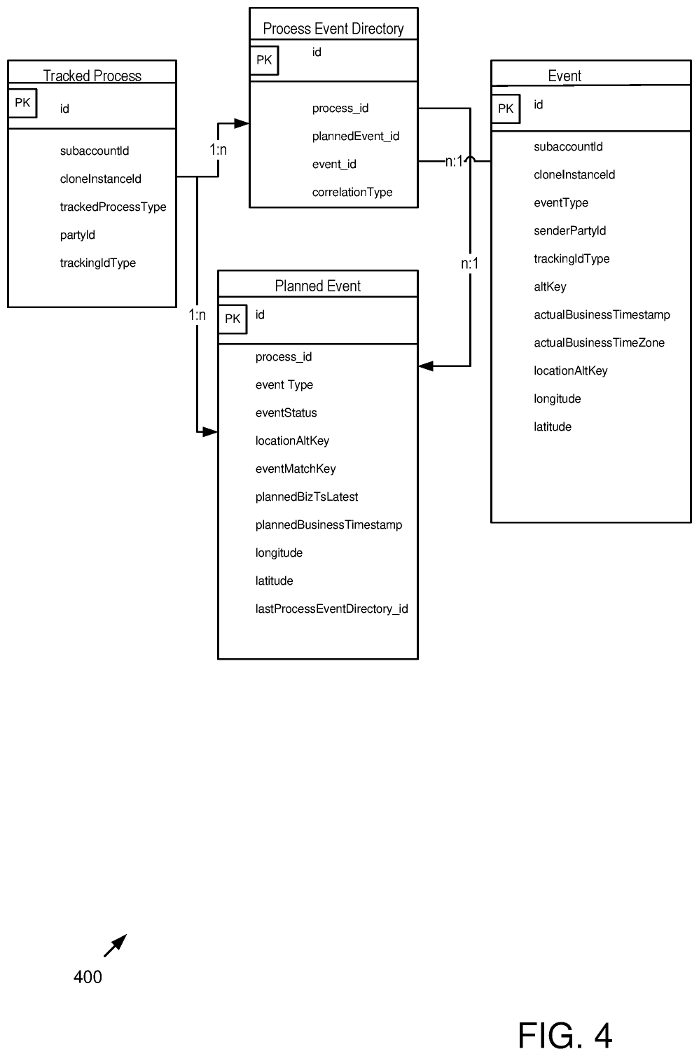

FIG. 4 is a block diagram showing an example schema structure 400 for representing tracked processes in a database accessed by a supply chain management application. In any of the examples herein, a tracked process can be represented in a tracked process table by a record having a primary key of id and attributes of subaccountId, cloneInstanceid, tracked ProcessType, partyId, and trackingIDType. There can be a 1:n relationship between the Tracked Process and Process Event Directory as well as Planned Event records, which also have a primary key of id but are also related to the Tracked Process via a process_id attribute.

The Process Event Directory table records can reference both planned events with a plannedEvent_id attribute and actual, observed events with an event_id. There can also be a correlationType attribute.

The Planned Event table records can include an attribute for eventType, eventStatus, locationAltKey, eventMatchKey, plannedBizTsLatest, plannedBusinessTimestamp, longitude, latitude, and lastProcessEventDirecotry_id.

As shown, the Process Event Directory can have an n: 1 relationship with the Planned Event records, and an n:1 relationship with the Event records.

The Event table records can represent actual, observed events and can have their own primary key of id and also include attributes of subaccountId, cloneInstanceId, eventType, senderPartyId, trackingIdType, altKey, actualBusinessTimestamp, actualBussinessTimeZone, locationAltKey, longitude, and latitude.

Other arrangements are possible to provide planned and actual event data for building a machine learning model and making predictions with such a model.

### Example 14—Example Training Data

If one assumes that a carrier needs to transport a truckload of cargo from location A to location B, a supply chain management application can plan the departure from location A as planned event PA and plan the arrival of location B as planned event PB. PA is a prerequisite of PB, which means that planned event PB will happen after planned event PA.

Because distance influences the time of the transportation, one can use location to indicate the distance. One can get the planned event location in the Planned Event table with the attribute locationAltKey as LOCALKEYA (Source Location A attribute) and LOCALTKEYB (Destination Location B attribute).

The planned time of departure from location A and arrival at location B are typically conventionally set by an experienced planner, which can influence the actual time consumed on the way. So, one can choose the planned business time stamp in the Planned Event table with attribute plannedBusinessTimestamp as PLANNED BIZTIMESTAMPA and PLANNEDBIZTIMESTAMPB, calculate with SECONDS_BETWEEN(PLANNEDBIZTIMESTAMPA, PLANNEDBIZTIMESTAMPB) as PLANNEDTIMEDIFF (estimated transit time attribute).

Different carriers have different transport efficiency, so one can take the senderPartyID of PA as CARRIERID (carrier identifier attribute) into consideration.

Day of the week can also be incorporated because it can affect shipping time. One can convert the PLANNEDBIZTIMESTAMPA to get day name DAYNAME(PLANNEDBIZTIMESTAMPA) as WEEKDAY representing a day-of-the-week of shipment attribute. The time of day can also influence transportation efficiency, so one can get the hour via HOUR(PLANNEDBIZTIMESTAMPA) as HOUR. As shown, the HOUR can be an integer representing an hour-of-the-day of shipment attribute.

For training to predict actual shipping time (actual transit time difference), one can get the actual shipping time in history, the actual business timestamp can be determined via the Event table with actualBusinessTimestamp as ACTBIZTIMESTAMPA and ACTBIZTIMESTAMPB, then one can calculate SECONDS_BETWEEN(ACTBIZTIMESTAMPA, ACTTIMESTAMPB) as ACTTIMEDIFF (actual time difference, that is observed transit time difference calculated from observed actual transit timestamps of past loads).

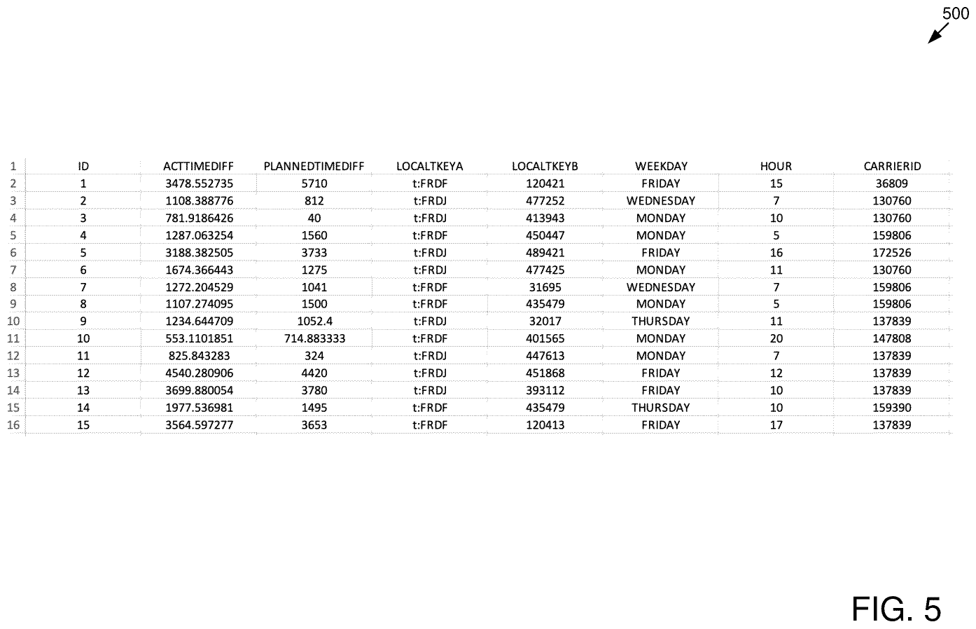

The training data can be prepared and marshaled for input to a training process. FIG. 5 is a is a block diagram of an example table 500 representing training data for a machine learning model that can be used to implement the technologies described herein. In the example, the data as described above is placed into a table.

The variable being predicted (dependent variable) is ACTTIMEDIFF. The other variables (independent variables) are features used during training that will subsequently be used as input features for future predictions.

### Example 15—Example Detailed Training Implementation

In practice, a table can be created and the model trained as follows. The specifics are expected to vary depending on the implementation:

1. Create parameter table to set parameters for training with SQL:
CREATE LOCAL TEMPORARY COLUMN TABLE #PAL_PARAMETER_TBL(“PARAM_NAME” VARCHAR(256), “INT_VALUE” INTEGER, “DOUBLE_VALUE” DOUBLE, “STRING_VALUE” VARCHAR(1000)); INSERT INTO #PAL_PARAMETER_TBL VALUES (′THREAD_RATIO′,NULL,0.5,NULL); INSERT INTO #PAL_PARAMETER_TBL VALUES (′PMML_EXPORT′,2,NULL,NULL); INSERT INTO #PAL_PARAMETER_TBL VALUES (′CATEGORICAL_VARIABLE′,NULL,NULL,′DAYHOUR′);

Default values can be used for any missing parameters.

2. Train the model with the PAL_PARAMETER_TBL and input data table PAL_TRAINING_DATA
CALL_SYS_AFL.PAL_LINEAR_REGRESSION(PAL_TRAINNING_DATA, “#PAL_PA RAMETER_TBL”,?,?,?,?,?);

After training, a coefficient table PAL_COE_TBL is generated to use in data prediction.

### Example 16—Example Input Data for Prediction

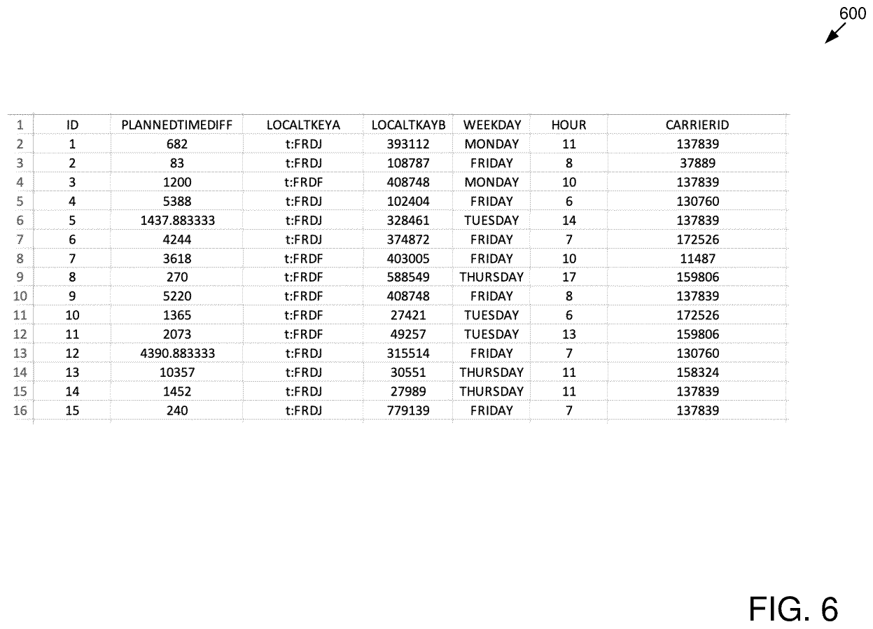

FIG. 6 is a block diagram of an example table 600 representing input (for prediction) data for a machine learning model that can be used to implement the technologies described herein. In the example, ACTTIMEDIFF is predicted with LOCALTKEYA, LOCALTKEYB, CARRIERID, WEEKDAY, HOUR, and PLANNED TIMEDIFF.

### Example 17—Example Detailed Prediction Implementation

In practice, prediction can be implemented as follows. The specifics are expected to vary depending on the implementation:

1. Create parameter table to set parameters with SQL:
CREATE LOCAL TEMPORARY COLUMN TABLE #PAL_PARAMETER_TBL (“PARAM_NAME” VARCHAR(256), “INT_VALUE” INTEGER, “DOUBLE_VALUE” DOUBLE, “STRING_VALUE” VARCHAR(1000)); INSERT INTO #PAL_PARAMETER_TBL VALUES (′THREAD_RATIO′,NULL,0.1,NULL);

Default values can be used for any missing parameters.

2. Predict ACTTIMEDIFF with input data table
PAL_PREDICT_INPUT_DATA, coefficient table PAL_COE_TBL and parameter table PAL_PARAMETER_TBL.
CALL_SYS_AFL.PAL_LINEAR_REGRESSION_PREDICT (PAL_PREDICT_INPUT_DATA, PAL_COE_TBL, “#PAL_PARAMETER_TBL”,?);

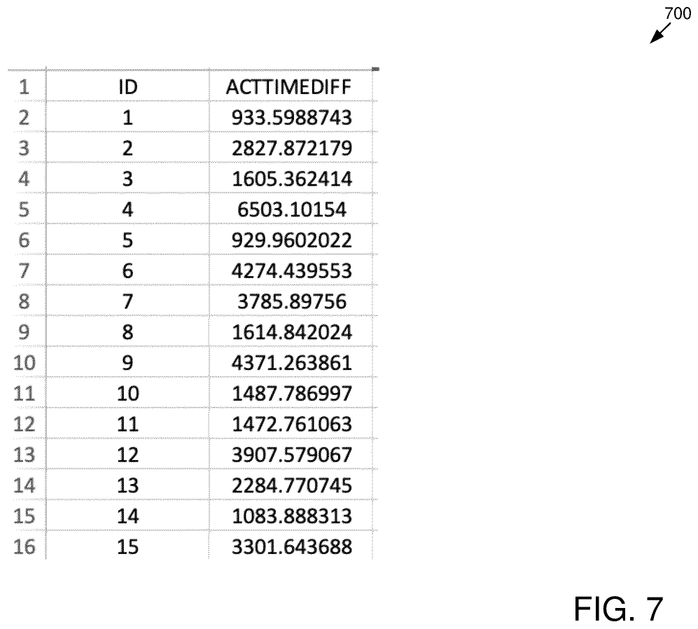

The predicted values can be returned in a FITTED table as shown in FIG. 7. Such a prediction can be used in any of the examples herein to generate a predicted actual transit time difference. One can then recommend a planned timestamp of planned event B as PLANNEDBIZTIMESTAMPA+ACTTIMEDIFF.

### Example 18—Example Software Architecture

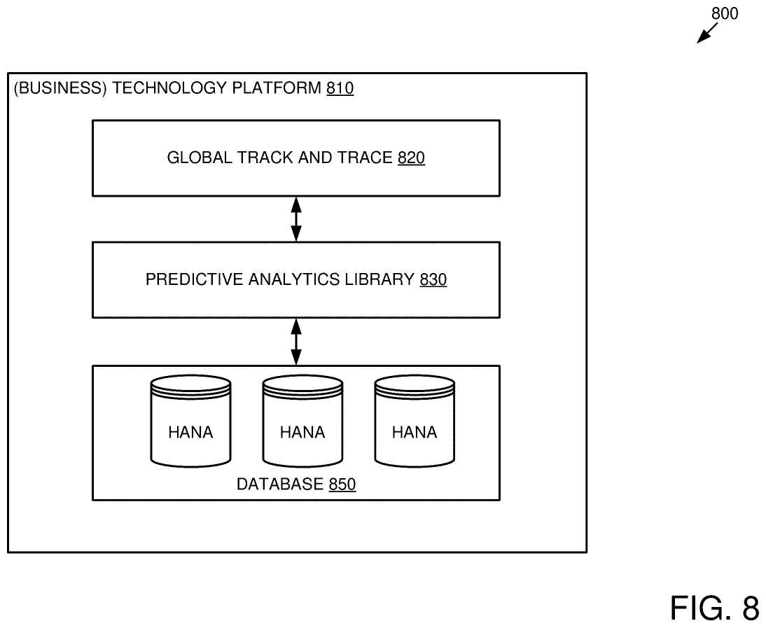

FIG. 8 is a block diagram of an example software architecture 800 implementing transportation prediction with a machine learning model that can be used to implement the technologies described herein. In the example, a technology platform 810 comprises a supply chain management application with a track and trace tool 820 that uses a predictive analysis library 830 to access database 850 that stores historical data for training as well as current data that can be used for predictions.

### Example 19—Example Linear Regression

In any of the examples herein, linear regression can be used for training and prediction. Linear regression is an approach to model the linear relationship of a variable Y ∈ [symbol] , usually referred to as a dependent variable, and one or more variables, usually referred to as independent variables, denoted as predictor vector X ∈ [symbol] ⁿ.

In linear regression, data are modeled using linear functions, and unknown model parameters are estimated from the data. Such models are called “linear models.”

Assuming one has m observation pairs (xᵢ, yᵢ), one can obtain an overdetermined linear system

$$[ \begin{matrix}1 & {x}_{1}^{T} \\ … & … \\ 1 & {x}_{m}^{T}\end{matrix} ] [ \begin{matrix}{β}_{0} \\ β\end{matrix} ] = Y ,$$

with

$$[ \begin{matrix}1 & {x}_{1}^{T} \\ … & … \\ 1 & {x}_{m}^{T}\end{matrix} ]$$

being an m×(n+1) matrix,

$$[ \begin{matrix}{β}_{0} \\ β\end{matrix} ]$$

is a (n+1)×1 matrix, where m>N+1. Because equality is usually not exactly satisfiable, when m>n+1, the least squares solution

$$[ \begin{matrix}{β}_{0} \\ β\end{matrix} ]$$

minimizes the squared Euclidean norm of the residual vector r

$$( [ \begin{matrix}{β}_{0} \\ β\end{matrix} ] )$$

so that

$${min}_{\{ {β}_{0} , β \} ∈ {R}^{n + 2}} {‖ r ( [ \begin{matrix}{β}_{0} \\ β\end{matrix} ] ) ‖}_{2}^{2} = {min}_{\{ {β}_{0} , β \} ∈ {R}^{n + 1}} ( {\sum }_{i = 1}^{m} {( {y}_{i} - {β}_{0} - {x}_{i}^{T} β )}^{2} ) \vert$$

Elastic net regularization for multiple linear regression seeks to find

$$[ \begin{matrix}{β}_{0} \\ β\end{matrix} ]$$

that minimizes:

$${min}_{\{ {β}_{0} , β \} ∈ {R}^{n + 1}} ( \frac{1}{2 m} {\sum }_{i = 1}^{m} {( {y}_{i} - {β}_{0} - {x}_{i}^{T} β )}^{2} + λ * {P}_{α} ( β ) )$$

$$Where {P}_{α} ( β ) = ( 1 - ∝ ) \frac{1}{2} {‖ β ‖}_{{1}_{2}}^{2} + ∝ {‖ β ‖}_{{1}_{1 ↵}} .$$

Here α Σ [0,1] and λ≥0. If α=0, we have the ridge regularization; if α=1, we have the LASSO regularization. The implementation also supports calculating F, R² and other statistics to determine statistical significance.

### Example 20—Example Implementations

Any of the following can be implemented.

Clause 1. A computer-implemented method comprising:
receiving a set of attributes for a planned load, wherein the attributes comprise an estimated transit time attribute and day-of-the-week attribute;
applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and
with the machine learning model, based on the attributes comprising the day-of-the-week attribute and the estimated transit time attribute, generating a predicted actual transit time difference.

Clause 2. The computer-implemented method of Clause 1 wherein:
a given observed transit time difference out of the observed transit time differences is calculated as a difference between an observed destination location timestamp and an observed source location timestamp for a past load.

Clause 3. The computer-implemented method of any one of Clauses 1-2 wherein:
the attributes comprise an hour-of-the-day attribute indicative of an hour of a day on which transit begins; and
the machine learning model is trained with the hour-of-the-day attribute as a feature.

Clause 4. The computer-implemented method of any one of Clauses 1-3 wherein:
the attributes comprise a carrier identifier attribute indicative of a carrier used for transit; and
the machine learning model is trained with the carrier identifier attribute.

Clause 5. The computer-implemented method of any one of Clauses 1-4 wherein:
the machine learning model comprises a linear model applying linear regression to model a linear relationship for predicted actual transit time difference as a dependent variable.

Clause 6. The computer-implemented method of Clause 5 wherein:
the machine learning model applies elastic net regularization.

Clause 7. The computer-implemented method of any one of Clauses 1-6 wherein:
the machine learning model comprises a neural network.

Clause 8. The computer-implemented method of any one of Clauses 1-7 further comprising:
responsive to determining that the predicted actual transit time difference deviates from the estimated transit time difference by a threshold, raising an alert.

Clause 9. The computer-implemented method of any one of Clauses 1-8 further comprising:
substituting the predicted actual transit time difference for the estimated transit time difference in a record representing the planned load.

Clause 10. The computer-implemented method of any one of Clauses 1-9 further comprising:
processing a deviation between the predicted actual transit time difference and the estimated transit time difference in a supply chain management application;
wherein the processing comprises displaying an alert and blocking processing until the deviation is under a configurable threshold.

Clause 11. The computer-implemented method of any one of Clauses 1-10 further comprising:
responsive to determining that deviation between the predicted actual transit time difference and the estimated transit time difference exceeds a threshold, presenting a user interface configured for re-entry of the attributes of the planned load and a deviation alert.

Clause 12. The computer-implemented method of any one of Clauses 1-11 further comprising:
responsive to determining that deviation between the predicted actual transit time difference and the estimated transit time difference exceeds a threshold, presenting a planner training user interface.

Clause 13. The computer-implemented method of any one of Clauses 1-12 wherein:
features used during training of the machine learning model comprise:
a carrier identifier attribute;
an hour-of-the-day of load attribute;
a source location attribute; and
a destination location attribute.

Clause 14. The computer-implemented method of any one of Clauses 1-13 further comprising:
training the machine learning model to predict actual transit time difference based on observed transit time differences calculated from observed actual transit timestamps of past loads, wherein the training attributes comprise the day-of-the-week attribute and the estimated transit time attribute.

Clause 15. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
receiving a set of attributes for a planned load, wherein the attributes comprise an estimated transit time attribute and day-of-the-week attribute;
applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and
with the machine learning model, based on the attributes comprising the day-of-the-week attribute and the estimated transit time attribute, generating a predicted actual transit time difference.

Clause 16. The computing system of Clause 15, wherein:
a given observed transit time difference out of the observed transit time differences is calculated as a difference between an observed destination location timestamp and an observed source location timestamp for a past load.

Clause 17. The computing system of any one of Clauses 15-16, wherein:
the attributes comprise an hour-of-the-day attribute indicative of an hour of the day on which transit begins; and
the machine learning model is trained with the hour-of-the-day attribute as a feature.

Clause 18. The computing system of any one of Clauses 15-17, wherein:
the machine learning model comprises a linear model applying linear regression to model a linear relationship for predicted actual transit time difference as a dependent variable.

Clause 19. The computing system of any one of Clauses 15-18, wherein:
features used during training of the machine learning model comprise:
a carrier identifier attribute;
an hour-of-the-day of load attribute;
a source location attribute; and
a destination location attribute.

Clause 20. One or more non-transitory computer-readable media having stored therein computer-executable instructions that when executed by a computing system, cause the computing system to perform:
receiving a set of attributes for a load, wherein the attributes comprise an estimated transit time of the load attribute, a day-of-the-week of the load attribute, an hour-of-the-day of the load attribute, and a carrier identifier of the load attribute;
applying the attributes to a machine learning model, wherein the machine learning model is trained with training attributes comprising the estimated transit time of the load attribute, the day-of-the-week attribute, the hour-of-the-day of the load attribute, and the carrier identifier attribute and the machine learning model is trained to predict observed transit time difference calculated from observed actual transit timestamps of past loads; and
with the machine learning model, based on the attributes, generating a predicted actual transit time difference indicating a prediction of an actual transit time.

Clause 21. One or more computer-readable media having encoded thereon computer-executable instructions that, when executed by a computing system, cause the computing system to perform the method of any one of Clauses 1-14.

Clause 22. A computing system comprising:
at least one hardware processor;
at least one memory coupled to the at least one hardware processor; and
one or more non-transitory computer-readable media having stored therein computer-executable instructions that, when executed by the computing system, cause the computing system to perform any one of the Clauses 1-14.

### Example 21—Example Computing Systems

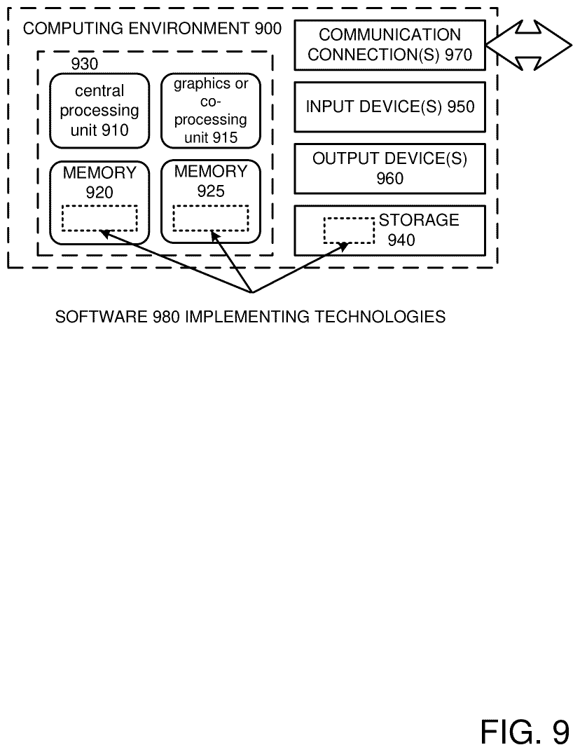

FIG. 9 depicts an example of a suitable computing system 900 in which the described innovations can be implemented. The computing system 900 is not intended to suggest any limitation as to scope of use or functionality of the present disclosure, as the innovations can be implemented in diverse computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 can be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 can have additional features. For example, the computing system 900 includes storage 940, one or more input devices 950, one or more output devices 960, and one or more communication connections 970, including input devices, output devices, and communication connections for interacting with a user. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 can be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 can be an input device such as a keyboard, mouse, pen, or trackball, a voice input device, a scanning device, touch device (e.g., touchpad, display, or the like) or another device that provides input to the computing system 900. The output device(s) 960 can be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 22—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 23—Example Cloud Computing Environment

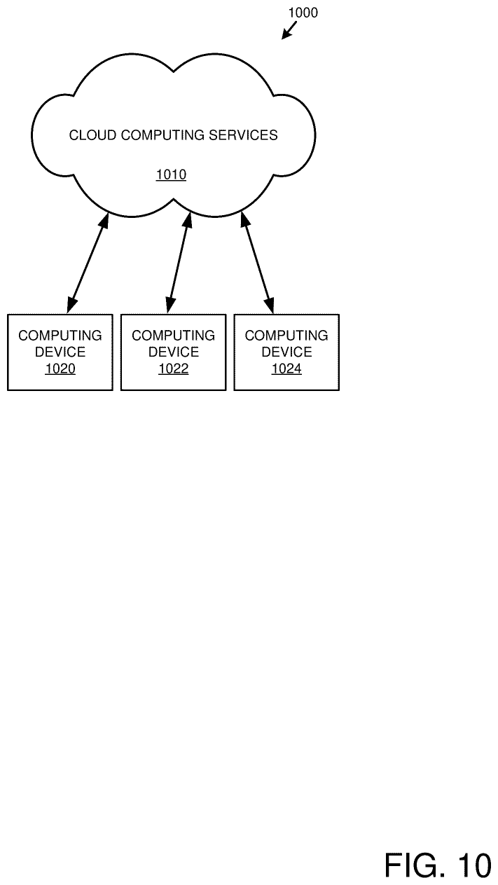

FIG. 10 depicts an example cloud computing environment 1000 in which the described technologies can be implemented, including, e.g., the system 100 of FIG. 1 and other systems herein. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

In practice, cloud-based, on-premises-based, or hybrid scenarios can be supported.

### Example 24—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 25—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a set of attributes for a planned load, wherein the attributes comprise an estimated transit time attribute and day-of-the-week attribute;
applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and
with the machine learning model, based on the attributes comprising the day-of-the-week attribute and the estimated transit time attribute, generating a predicted actual transit time difference.

2. The computer-implemented method of claim 1 wherein:
a given observed transit time difference out of the observed transit time differences is calculated as a difference between an observed destination location timestamp and an observed source location timestamp for a past load.

3. The computer-implemented method of claim 1 wherein:
the attributes comprise an hour-of-the-day attribute indicative of an hour of a day on which transit begins; and
the machine learning model is trained with the hour-of-the-day attribute as a feature.

4. The computer-implemented method of claim 1 wherein:
the attributes comprise a carrier identifier attribute indicative of a carrier used for transit; and
the machine learning model is trained with the carrier identifier attribute.

5. The computer-implemented method of claim 1 wherein:
the machine learning model comprises a linear model applying linear regression to model a linear relationship for predicted actual transit time difference as a dependent variable.

6. The computer-implemented method of claim 5 wherein:
the machine learning model applies elastic net regularization.

7. The computer-implemented method of claim 1 wherein:
the machine learning model comprises a neural network.

8. The computer-implemented method of claim 1 further comprising:
responsive to determining that the predicted actual transit time difference deviates from the estimated transit time difference by a threshold, raising an alert.

9. The computer-implemented method of claim 1 further comprising:
substituting the predicted actual transit time difference for the estimated transit time difference in a record representing the planned load.

10. The computer-implemented method of claim 1 further comprising:
processing a deviation between the predicted actual transit time difference and the estimated transit time difference in a supply chain management application;
wherein the processing comprises displaying an alert and blocking processing until the deviation is under a configurable threshold.

11. The computer-implemented method of claim 1 further comprising:
responsive to determining that deviation between the predicted actual transit time difference and the estimated transit time difference exceeds a threshold, presenting a user interface configured for re-entry of the attributes of the planned load and a deviation alert.

12. The computer-implemented method of claim 1 further comprising:
responsive to determining that deviation between the predicted actual transit time difference and the estimated transit time difference exceeds a threshold, presenting a planner training user interface.

13. The computer-implemented method of claim 1 wherein:
features used during training of the machine learning model comprise:
a carrier identifier attribute;
an hour-of-the-day of load attribute;
a source location attribute; and
a destination location attribute.

14. The computer-implemented method of claim 1 further comprising:
training the machine learning model to predict actual transit time difference based on observed transit time differences calculated from observed actual transit timestamps of past loads, wherein the training attributes comprise the day-of-the-week attribute and the estimated transit time attribute.

15. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
receiving a set of attributes for a planned load, wherein the attributes comprise an estimated transit time attribute and day-of-the-week attribute;
applying the attributes to a machine learning model, wherein the machine learning model is trained with training attributes comprising the day-of-the-week attribute and the estimated transit time attribute and is trained to predict actual transit time difference based on observed transit time differences calculated from observed actual transit timestamps of past loads; and
with the machine learning model, based on the attributes comprising the day-of-the-week attribute and the estimated transit time attribute, generating a predicted actual transit time difference.

16. The computing system of claim 15, wherein:
a given observed transit time difference out of the observed transit time differences is calculated as a difference between an observed destination location timestamp and an observed source location timestamp for a past load.

17. The computing system of claim 15, wherein:
the attributes comprise an hour-of-the-day attribute indicative of an hour of the day on which transit begins; and
the machine learning model is trained with the hour-of-the-day attribute as a feature.

18. The computing system of claim 15, wherein:
the machine learning model comprises a linear model applying linear regression to model a linear relationship for predicted actual transit time difference as a dependent variable.

19. The computing system of claim 15, wherein:
features used during training of the machine learning model comprise:
a carrier identifier attribute;
an hour-of-the-day of load attribute;
a source location attribute; and
a destination location attribute.

20. One or more non-transitory computer-readable media having stored therein computer-executable instructions that when executed by a computing system, cause the computing system to perform:
receiving a set of attributes for a load, wherein the attributes comprise an estimated transit time of the load attribute, a day-of-the-week of the load attribute, an hour-of-the-day of the load attribute, and a carrier identifier of the load attribute;
applying the attributes to a machine learning model, wherein the machine learning model is trained with training attributes comprising the estimated transit time of the load attribute, the day-of-the-week attribute, the hour-of-the-day of the load attribute, and the carrier identifier attribute and the machine learning model is trained to predict observed transit time difference calculated from observed actual transit timestamps of past loads; and
with the machine learning model, based on the attributes, generating a predicted actual transit time difference indicating a prediction of an actual transit time.
